(19) United States
(12) Patent Application Publication
(10) Pub. No.: US 2024/0179321 A1
(43) Pub. Date: May 30, 2024

(54) IMAGE DECODING DEVICE, IMAGE DECODING METHOD, AND PROGRAM

(71) Applicant: KDDI CORPORATION, Tokyo (JP)

(72) Inventors: Yoshitaka KIDANI, Fujimino-shi (JP); Kei KAWAMURA, Fujimino-shi (JP)

(73) Assignee: KDDI CORPORATION, Tokyo (JP)

(21) Appl. No.: 18/393,949

(22) Filed: Dec. 22, 2023

Related U.S. Application Data
(63) Continuation of application No. PCT/JP2022/026106, filed on Jun. 29, 2022.

(30) Foreign Application Priority Data
Jun. 29, 2021 (JP) 2021-108102

(51) Int. Cl. H04N 19/139; G06V 10/75; H04N 19/176; H04N 19/46; H04N 19/70

(52) U.S. Cl. CPC H04N 19/139; G06V 10/751; H04N 19/176; H04N 19/46; H04N 19/70

(57) ABSTRACT

In an image decoding device according to the present invention, a merge candidate in a merge list of the normal merge mode is configured to be generated and stored by a spatial merge candidate, a temporal merge candidate, a non-adjacent merge candidate, a history merge candidate, a pairwise merge candidate, or a zero merge candidate, and a decoding unit (210) is configured to specify the merge candidate from zeroth to fourth merge candidates in the merge list based on syntax (mmvd_cand_idx) transmitted from an image encoding device (100).

### CROSS-REFERENCE TO RELATED APPLICATIONS

The present application is a continuation of PCT Application No. PCT/JP2022/026106, filed on Jun. 29, 2022, which claims the benefit of Japanese patent application No. 2021-108102 filed on Jun. 29, 2021, the entire contents of which are incorporated herein by reference in its entirety.

### TECHNICAL FIELD

The present invention relates to an image decoding device, an image decoding method, a program.

### BACKGROUND ART

Non Patent Literature 1 (ITU-H.26/VVC) discloses a merge with motion vector difference (MMVD). The MMVD transmits a motion vector difference (MVD) of a limited pattern with respect to a motion vector (MV) in the normal merge mode, and adds the motion vector difference (MVD) to a target MV.

Here, in Non Patent Literature 1, the maximum number of merge candidates in the normal merge mode is six, and among them, merge candidates to which the MMVD is applicable are limited to the zeroth and the first two merge candidates in a merge list.

Non Patent Literature 2 (JVET-U0100) discloses a non-adjacent spatial merge candidate as a merge candidate in the normal merge mode.

Here, the non-adjacent spatial merge candidate is stored in the merge list at a position after the spatial merge candidate and the temporal merge candidate disclosed in Non Patent Literature 1 and at a position before the history merge candidate. In addition, in Non Patent Literature 2, the maximum number of merge candidates in the normal merge mode is extended to ten as compared with Non Patent Literature 1.

Non Patent Literature 3 (JVET-V0099) discloses adaptive reordering merge candidates (ARMC) using template matching.

Here, the ARMC reorders the storage order of the merge candidates in the merge list in ascending order of SAD values by template matching for comparing sum of absolute difference (SAD) values of the reconfiguration pixels (templates) adjacent to the target block and the reference block.

### SUMMARY OF THE INVENTION

However, in Non Patent Literature 1, since the merge candidates to which the MMVD is applicable are limited to the zeroth and the first merge candidates in the merge list, there is room for improvement in encoding performance.

Therefore, the present invention was conceived in view of the foregoing problem, and an object thereof is to provide an image decoding device, an image decoding method, and a program capable of further improving encoding performance.

The first aspect of the present invention is summarized as an image decoding device including a circuit, wherein the circuit: specifies a merge candidate in a merge list of a normal merge mode for adding a direction, a distance, and an MVD in a merge with motion vector difference, based on syntax transmitted from an image encoding device; and adds the MVD to an MV indicated by the specified merge candidate to refine the MV, wherein a merge candidate in a merge list of the normal merge mode is generated and stored by a spatial merge candidate, a temporal merge candidate, a non-adjacent merge candidate, a history merge candidate, a pairwise merge candidate, or a zero merge candidate, and the circuit specifies the merge candidate from zeroth to fourth merge candidates in the merge list based on syntax transmitted from the image encoding device.

The second aspect of the present invention is summarized as an image decoding method including: specifying a merge candidate in a merge list of a normal merge mode for adding a direction, a distance, and an MVD in a merge with motion vector difference, based on syntax transmitted from an image encoding device; and adding the MVD to an MV indicated by the specified merge candidate to refine the MV, wherein a merge candidate in a merge list of the normal merge mode is generated and stored by a spatial merge candidate, a temporal merge candidate, a non-adjacent merge candidate, a history merge candidate, a pairwise merge candidate, or a zero merge candidate, and
in the specifying, the merge candidate is specified from zeroth to fourth merge candidates in the merge list based on syntax transmitted from the image encoding device.

The third aspect of the present invention is summarized as a program stored on a non-transitory computer-readable medium causing a computer to function as an image decoding device, the image decoding device including a circuit, wherein the circuit: specifies a merge candidate in a merge list of a normal merge mode for adding a direction, a distance, and an MVD in a merge with motion vector difference, based on syntax transmitted from an image encoding device; and adds the MVD to an MV indicated by the specified merge candidate to refine the MV, wherein a merge candidate in a merge list of the normal merge mode is generated and stored by a spatial merge candidate, a temporal merge candidate, a non-adjacent merge candidate, a history merge candidate, a pairwise merge candidate, or a zero merge candidate, and the circuit specifies the merge candidate from zeroth to fourth merge candidates in the merge list based on syntax transmitted from the image encoding device.

According to the present invention, it is possible to provide an image decoding device, an image decoding method, and a program capable of further improving encoding performance.

### BRIEF DESCRIPTION OF THE DRAWINGS

FIG. 1 is a diagram illustrating an example of a configuration of an image processing system 1 according to an embodiment.

FIG. 2 is a diagram illustrating an example of functional blocks of an image encoding device 100 according to an embodiment.

FIG. 3 is a diagram illustrating an example of functional blocks of an image decoding device 200 according to an embodiment.

FIG. 4 is a diagram illustrating an example of a configuration of encoded data (bit stream) received by a decoding unit 210 disclosed in Non Patent Literature 1.

FIG. 5 is a diagram illustrating an example of a correspondence table of the magnitude (distance) of an MVD in an MMVD corresponding to the value of mmvd_distance_idx disclosed in Non Patent Literature 1.

FIG. 6 is a diagram illustrating an example of a correspondence table of a direction of the MVD in the MMVD corresponding to the value of mmvd_direction_idx disclosed in Non Patent Literature 1.

FIG. 7 is a diagram illustrating an example of functional blocks of an inter prediction unit 241 according to an embodiment.

FIG. 8 is a diagram for describing an example of an operation of a TM unit 241A4 of a motion vector decoding unit 241A of an inter prediction unit 241 according to an embodiment.

FIG. 9 is a diagram for describing harmonization of an MMVD and TM according to an embodiment.

### DESCRIPTION OF EMBODIMENTS

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

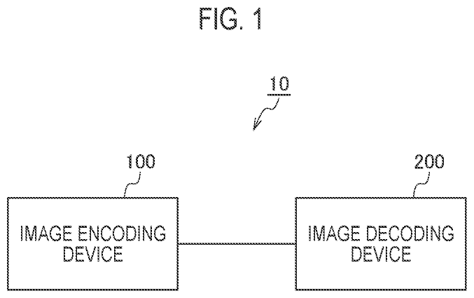

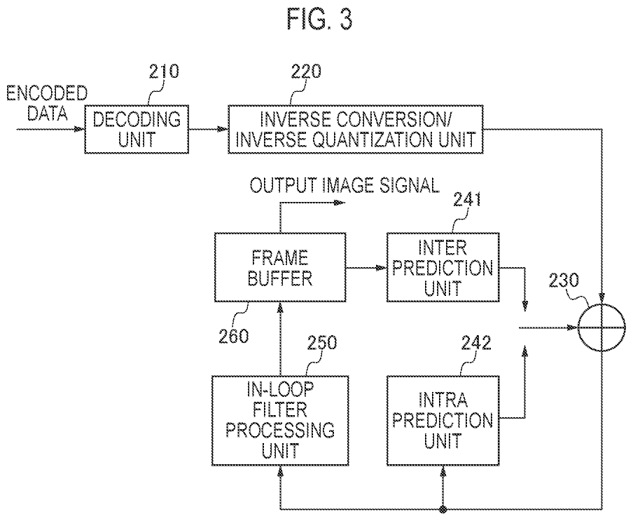

Hereinafter, an image processing system 10 according to a first embodiment of the present invention will be described with reference to FIGS. 1 to 7. FIG. 1 is a diagram illustrating the image processing system 10 according to the present embodiment.

### (Image Processing System 100)

As illustrated in FIG. 1, the image processing system 10 according to the present embodiment includes an image coding device 100 and an image decoding device 200.

The image coding device 100 is configured to generate coded data by coding an input image signal (picture). The image decoding device 200 is configured to generate an output image signal by decoding the coded data.

The coded data may be transmitted from the image coding device 100 to the image decoding device 200 via a transmission path. The coded data may be stored in a storage medium and then provided from the image coding device 100 to the image decoding device 200.

### (Image Coding Device 100)

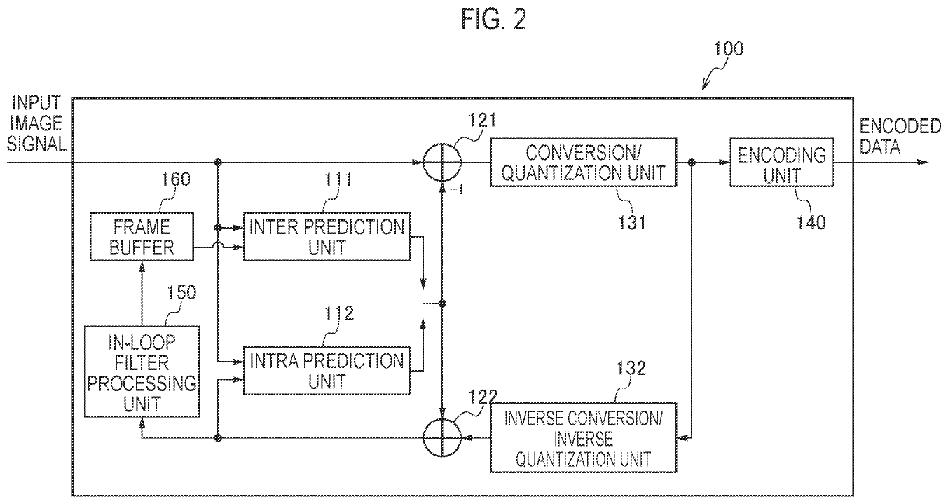

Hereinafter, the image coding device 100 according to the present embodiment will be described with reference to FIG. 2. FIG. 2 is a diagram illustrating an example of functional blocks of the image coding device 100 according to the present embodiment.

As shown in FIG. 2, the image coding device 100 includes an inter prediction unit 111, an intra prediction unit 112, a subtractor 121, an adder 122, a transform/quantization unit 131, an inverse transform/inverse quantization unit 132, a coding unit 140, an in-loop filtering processing unit 150, and a frame buffer 160.

The inter prediction unit 111 is configured to generate a prediction signal by inter prediction (inter-frame prediction).

Specifically, the inter prediction unit 111 is configured to specify a reference block included in a reference frame by comparing a frame to be coded (hereinafter, referred to as a target frame) with the reference frame stored in the frame buffer 160, and determine a motion vector (mv) for the specified reference block.

The inter prediction unit 111 is configured to generate the prediction signal included in a block to be coded (hereinafter, referred to as a target block) for each target block based on the reference block and the motion vector. The inter prediction unit 111 is configured to output the prediction signal to the subtractor 121 and the adder 122. Here, the reference frame is a frame different from the target frame.

The intra prediction unit 112 is configured to generate a prediction signal by intra prediction (intra-frame prediction).

Specifically, the intra prediction unit 112 is configured to specify the reference block included in the target frame, and generate the prediction signal for each target block based on the specified reference block. Furthermore, the intra prediction unit 112 is configured to output the prediction signal to the subtractor 121 and the adder 122.

Here, the reference block is a block referred to for the target block. For example, the reference block is a block adjacent to the target block.

The subtractor 121 is configured to subtract the prediction signal from the input image signal, and output a prediction residual signal to the transform/quantization unit 131. Here, the subtractor 121 is configured to generate the prediction residual signal that is a difference between the prediction signal generated by intra prediction or inter prediction and the input image signal.

The adder 122 is configured to add the prediction signal to the prediction residual signal output from the inverse transform/inverse quantization unit 132 to generate a pre-filtering decoded signal, and output the pre-filtering decoded signal to the intra prediction unit 112 and the in-loop filtering processing unit 150.

Here, the pre-filtering decoded signal constitutes the reference block used by the intra prediction unit 112.

The transform/quantization unit 131 is configured to perform transform processing for the prediction residual signal and acquire a coefficient level value. Furthermore, the transform/quantization unit 131 may be configured to perform quantization of the coefficient level value.

Here, the transform processing is processing of transforming the prediction residual signal into a frequency component signal. In such transform processing, a base pattern (transformation matrix) corresponding to discrete cosine transform (Hereinafter referred to as DCT) may be used, or a base pattern (transformation matrix) corresponding to discrete sine transform (Hereinafter referred to as DST) may be used.

The inverse transform/inverse quantization unit 132 is configured to perform inverse transform processing for the coefficient level value output from the transform/quantization unit 131. Here, the inverse transform/inverse quantization unit 132 may be configured to perform inverse quantization of the coefficient level value prior to the inverse transform processing.

Here, the inverse transform processing and the inverse quantization are performed in a reverse procedure to the transform processing and the quantization performed by the transform/quantization unit 131.

The coding unit 140 is configured to code the coefficient level value output from the transform/quantization unit 131 and output coded data.

Here, for example, the coding is entropy coding in which codes of different lengths are assigned based on a probability of occurrence of the coefficient level value.

Furthermore, the coding unit 140 is configured to code control data used in decoding processing in addition to the coefficient level value.

Here, the control data may include size data such as a coding block (coding unit (CU)) size, a prediction block (prediction unit (PU)) size, and a transform block (transform unit (TU)) size.

Furthermore, the control data may include header information such as a sequence parameter set (SPS), a picture parameter set (PPS), and a slice header as described later.

The in-loop filtering processing unit 150 is configured to execute filtering processing on the pre-filtering decoded signal output from the adder 122 and output the filtered decoded signal to the frame buffer 160.

Herein, for example, the filter processing is deblocking filter processing, which reduces the distortion generated at boundary parts of blocks (encoded blocks, prediction blocks, or conversion blocks), or adaptive loop filter processing, which switches filters based on filter coefficients, filter selection information, local properties of picture patterns of an image, etc. transmitted from the image encoding device 100.

The frame buffer 160 is configured to accumulate the reference frames used by the inter prediction unit 111.

Here, the filtered decoded signal constitutes the reference frame used by the inter prediction unit 111.

### (Image Decoding Device 200)

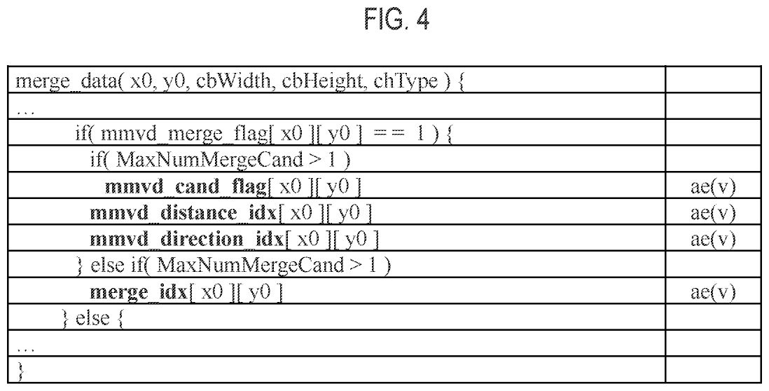

Hereinafter, the image decoding device 200 according to the present embodiment will be described with reference to FIG. 4. FIG. 4 is a diagram illustrating an example of functional blocks of the image decoding device 200 according to the present embodiment.

As illustrated in FIG. 4, the image decoding device 200 includes a decoding unit 210, an inverse transform/inverse quantization unit 220, an adder 230, an inter prediction unit 241, an intra prediction unit 242, an in-loop filtering processing unit 250, and a frame buffer 260.

The decoding unit 210 is configured to decode the coded data generated by the image coding device 100 and decode the coefficient level value.

Here, the decoding is, for example, entropy decoding performed in a reverse procedure to the entropy coding performed by the coding unit 140.

Furthermore, the decoding unit 210 may be configured to acquire control data by decoding processing for the coded data. Note that, as described above, the control data may include size data such as a coding block size, a prediction block size, and a transform block size.

The inverse transform/inverse quantization unit 220 is configured to perform inverse transform processing for the coefficient level value output from the decoding unit 210. Here, the inverse transform/inverse quantization unit 220 may be configured to perform inverse quantization of the coefficient level value prior to the inverse transform processing.

Here, the inverse transform processing and the inverse quantization are performed in a reverse procedure to the transform processing and the quantization performed by the transform/quantization unit 131.

The adder 230 is configured to add the prediction signal to the prediction residual signal output from the inverse transform/inverse quantization unit 220 to generate a pre-filtering decoded signal, and output the pre-filtering decoded signal to the intra prediction unit 242 and the in-loop filtering processing unit 250.

Here, the pre-filtering decoded signal constitutes a reference block used by the intra prediction unit 242.

Similarly to the inter prediction unit 111, the inter prediction unit 241 is configured to generate a prediction signal by inter prediction (inter-frame prediction).

Specifically, the inter prediction unit 241 is configured to generate the prediction signal for each prediction block based on the motion vector decoded from the coded data and the reference signal included in the reference frame. The inter prediction unit 241 is configured to output the prediction signal to the adder 230.

Similarly to the intra prediction unit 112, the intra prediction unit 242 is configured to generate a prediction signal by intra prediction (intra-frame prediction).

Specifically, the intra prediction unit 242 is configured to specify the reference block included in the target frame, and generate the prediction signal for each prediction block based on the specified reference block. The intra prediction unit 242 is configured to output the prediction signal to the adder 230.

Similarly to the in-loop filtering processing unit 150, the in-loop filtering processing unit 250 is configured to execute filtering processing on the pre-filtering decoded signal output from the adder 230 and output the filtered decoded signal to the frame buffer 260.

Herein, for example, the filter processing is deblocking filter processing, which reduces the distortion generated at boundary parts of blocks (encoded blocks, prediction blocks, conversion blocks, or sub-blocks obtained by dividing them), or adaptive loop filter processing, which switches filters based on filter coefficients, filter selection information, local properties of picture patterns of an image, etc. transmitted from the image encoding device 100.

Similarly to the frame buffer 160, the frame buffer 260 is configured to accumulate the reference frames used by the inter prediction unit 241.

Here, the filtered decoded signal constitutes the reference frame used by the inter prediction unit 241.

### (Decoding Unit 210)

Control data decoded by a decoding unit 210 will be described below with reference to FIGS. 4 to 7.

FIG. 4 is an example of a configuration of encoded data (bit stream) received by the decoding unit 210 disclosed in Non Patent Literature 1.

The decoding unit 210 is configured to decode mmvd_cand_flag when mmvd_merge_flag is 1 and MaxNumMergeCand is greater than 1.

Here, mmvd_merge_flag is a flag that specifies whether or not the MMVD is applied to the target block, MaxNumMergeCand is the maximum number of merge candidates in the merge list of the target block, and mmvd_cand_flag is a flag indicating a merge candidate number to which the MMVD is applied.

In Non Patent Literature 1, since the merge candidates to which the MMVD is applicable are limited to the 0th and 1st merge candidates in the merge list, when MaxNumMergeCand, which is the maximum number of merge candidates in the merge list of the target block, is larger than 1, mmvd_cand_flag is decoded and its value is specified.

In addition, in Non Patent Literature 1, in other cases (that is, when MaxNumMergeCand is 1), since it is obvious that the MMVD application target is the zeroth merge candidate in the merge list, mmvd_cand_flag is not decoded and is estimated as 0.

The decoding unit 210 is further configured to decode mmvd_distance_idx and mmvd_direction_idx when mmvd_merge_flag is 1.

Here, mmvd_distance_idx and mmvd_direction_idx are syntax for specifying the magnitude (distance) and direction of the motion vector difference, respectively, in the merge motion vector difference disclosed in Non Patent Literature 1.

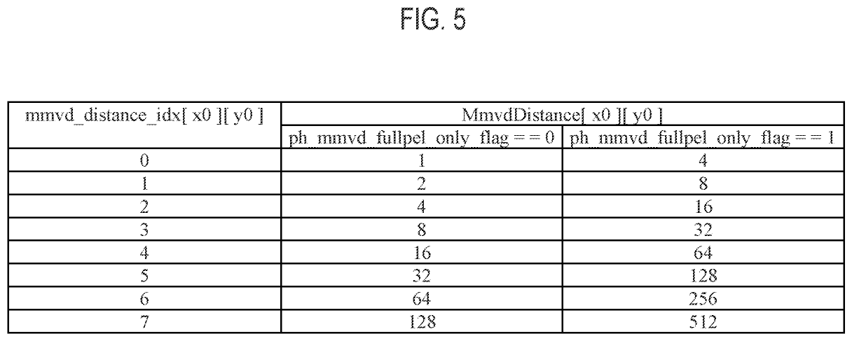

FIG. 5 illustrates an example of a correspondence table of the magnitude (distance) of the MVD in the MMVD corresponding to the value of mmvd_distance_idx disclosed in Non Patent Literature 1.

As illustrated in FIG. 5, the magnitude (distance) of the MVD can be specified by mmvd_distance_idx and a value of ph_mmvd_fullpel_only_flag transmitted in units of pictures disclosed in Non Patent Literature 1.

Here, the distance of the MVD is defined by a discrete value in the MmvdDistance illustrated in FIG. 5 starting from an MV in the merge mode.

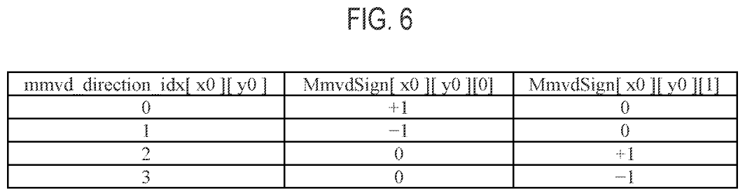

FIG. 6 illustrates an example of a correspondence table of a direction of the MVD in the MMVD corresponding to the value of mmvd_direction_idx disclosed in Non Patent Literature 1.

As illustrated in FIG. 6, the direction of the MVD can be specified by the value of mmvd_direction_idx.

Here, as the direction of the MVD, four directions of up, down, left, and right with the MV of the merge mode as a starting point are defined. Further, the up, down, left, and right directions are indicated by signs in a (x, y) direction with the MV of the merge mode as a center coordinate.

The sign of the (x, y) direction corresponds to MmvdSign [x0] [y0] [0] and MmvdSign [x0] [y0] [1] illustrated in FIG. 6, the left direction (that is, in the 0° direction) is (+1, 0), the right direction (that is, in the 180° direction) is (−1, 0), the up direction (that is, in the 90° direction) is (0, +1), and the down direction (that is, in the 270° direction) is (0, −1).

The decoding unit 210 is configured to transmit the MMVD application target merge candidate, the magnitude (distance) of the MVD, and the direction of the MVD, which can be specified as described above, to an MMVD unit 241A3 of an inter prediction unit 241 described later.

### (Inter Prediction Unit 241)

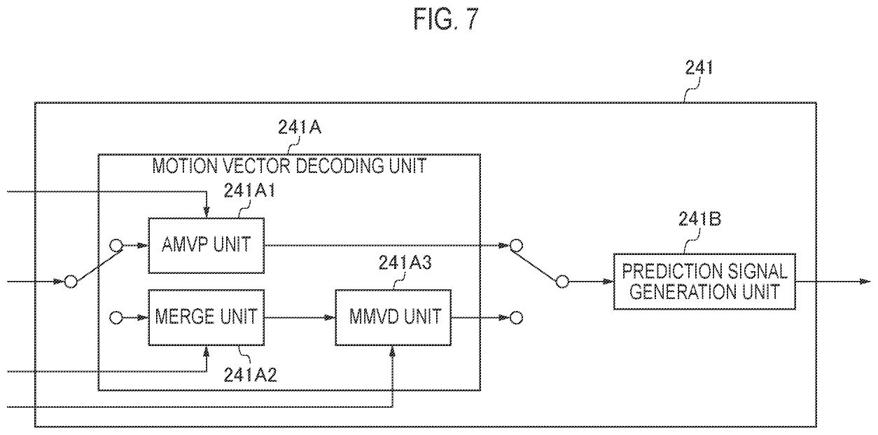

Hereinafter, the inter prediction unit 241 according to the present embodiment will be described with reference to FIGS. 7 to 9. FIG. 7 is a diagram illustrating an example of functional blocks of the inter prediction unit 241 according to the present embodiment.

As illustrated in FIG. 7, the inter prediction unit 241 includes a motion vector decoding unit 241A and a prediction signal generation unit 241B.

The inter prediction unit 241 is an example of a prediction unit configured to generate a prediction signal included in a prediction block on the basis of a motion vector.

The motion vector decoding unit 241A is configured to acquire a motion vector using the target frame and the reference frame input from a frame buffer 260 and the control data received from an image encoding device 100.

The motion vector decoding unit 241A includes an AMVP unit 241A1, a merge unit 241A2, and an MMVD unit 241A3.

The AMVP unit 241A1 is configured to perform adaptive motion vector prediction (AMVP) decoding for decoding a motion vector by using motion vector prediction (MVP), an index indicating a motion vector difference, and a list and an index of a reference frame.

Here, since the AMVP can employ a known method, the details thereof will be omitted.

The merge unit 241A2 is configured to receive the merge index (merge_idx) from the image encoding device 100 and decode the motion vector.

Specifically, the merge unit 241A2 is configured to construct a merge list in the same manner as the image encoding device 100 and acquire a motion vector corresponding to the received merge index from the constructed merge list.

Here, as a merge list construction method, a known method disclosed in Non Patent Literature 1 or Non Patent Literature 2 can be employed in the present embodiment. Specifically, that is as follows.

First, the maximum number of merge candidates stored in the merge lists in Non Patent Literature 1 and Non Patent Literature 2 is six and ten, respectively.

Next, in Non Patent Literature 1, merge candidates are stored in a merge list in the order of a spatial merge candidate, a temporal merge candidate, a history merge candidate, a pairwise merge candidate, and a zero merge candidate.

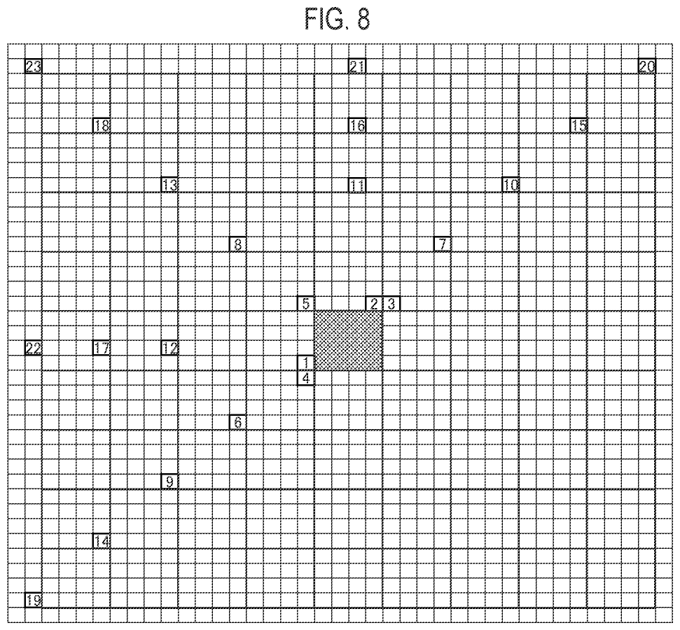

Here, the spatial merge candidate is a technique of acquiring motion information from adjacent positions of the target blocks illustrated in No. 1 to No. 5 of FIG. 8.

In Non Patent Literature 2, a non-adjacent spatial merge candidate is added to Non Patent Literature 1. Specifically, the non-adjacent spatial merge candidate is a technique of acquiring motion information from non-adjacent positions of the target blocks illustrated in No. 6 and subsequent of FIG. 8.

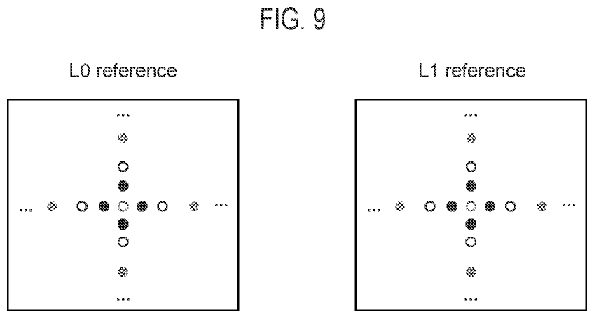

On the other hand, a history merge candidate disclosed in Non Patent Literature 1 or Non Patent Literature 2 is a technique of storing and updating motion information of a block decoded (encoded) before a target block in a FIFO history table illustrated in FIG. 9, and storing merge candidates in a merge list in ascending order of numbers of the history table.

When the merge candidates are stored in the merge list or when the merge candidates are stored in the history table, the merge candidate, the motion vector and the reference frame already stored in the merge list, and the presence or absence of the motion vector of each merge candidate are compared, and it is determined whether or not to newly store the merge candidates in the merge list. Such comparison processing is called Pruning processing, and is designed such that merge candidates having the same motion vector and reference frame are not stored in the merge list.

The MMVD unit 241A3 is configured to select a merge candidate in the merge list constructed by the above-described merge unit 241A2, decode the motion vector for the merge candidate, and add the MVD to the motion vector on the basis of the information indicating whether or not the MMVD can be applied to the target block sent from the decoding unit 210, the merge candidate number to which the MMVD is applied, and the information regarding the magnitude (distance) and direction of the MVD in the MMVD to refine the motion vector.

In the present embodiment, the MMVD applicable merge candidates may be extended not only from the zeroth and the first in the merge list but also from the zeroth to the fourth. That is, it can be realized by replacing the above mmvd_cand_flag (having values of 0 and 1) with mmvd_cand_idx (having values of 0 to 3), and causing the decoding unit 210 to decode mmvd_cand_idx and transmit the decoded mmvd_cand_idx to the MMVD unit 241A3.

In other words, the decoding unit 210 may be configured to specify a merge candidate from the zeroth to the fourth merge candidates in the merge list on the basis of the syntax (mmvd_cand_idx) transmitted from the image encoding device 100.

By extending the number of merge candidates to which the MMVD is applicable, the accuracy of the MV as a base to which the MVD is added by the MMVD is improved, and as a result, the prediction performance is improved.

Here, mmvd_cand_idx may be changed in consideration of the maximum number of candidates of the merge list, the type of the merge candidate, and the order of generation thereof.

Specifically, it is known that MMVD has a property of being easily applied to a video in which a background moves relatively slowly. Therefore, it is easy to acquire motion information from a decoded (encoded) block located in the same frame as the block, such as a spatial merge candidate, a non-adjacent spatial merge candidate, or a history merge candidate, and add MVD to the motion vector.

Therefore, if the maximum number of candidates of the merge list is changed to a number in which the merge candidate is easily stored by the spatial merge candidate, the non-adjacent spatial merge candidate, or the history merge candidate by the designer's intention, the effectiveness of the MMVD can be improved. For example, in Non Patent Literature 1 and Non Patent Literature 2, as described above, the maximum number of merge candidates is 6 and 10, and the merge candidates are stored in the order as described above. Therefore, for example, the maximum number of merge candidates to which the MMVD is applicable may be set to the fourth and eighth.

### Modified Example 1

In Non Patent Literature 1 or Non Patent Literature 2, it is not possible to determine from which merge candidate type each merge candidate is stored when each merge candidate is stored in the merge list. However, by including an internal parameter capable of determining from which merge candidate type the merge candidate is stored together with the merge candidate, the merge candidate to which the MMVD can be applied may be limited to the above-described spatial merge candidate, non-adjacent spatial merge candidate, or history merge candidate.

That is, the decoding unit 210 may be configured to specify a merge candidate from among a spatial merge candidate, a non-adjacent spatial merge candidate, and a history merge candidate on the basis of syntax (mmvd_cand_idx) transmitted from the image encoding device 100.

As a result, since the application target of the MMVD can be limited to the merge candidate having high effectiveness of the MMVD, the effectiveness of the MMVD can be improved.

### Modified Example 2

As a further modified example, the Pruning processing in Non Patent Literature 1 or Non Patent Literature 2 may be enhanced.

Specifically, in Non Patent Literature 1 or Non Patent Literature 2, the storage of a new merge candidate in the merge list is prohibited only when the motion vector and the reference frame indicated by the already stored merge candidate are the same, but it may be prohibited only when only the motion vector is the same.

As a result, it is possible to increase a variation of the MV to which the MVD is added in the MMVD, and it is expected that prediction performance is improved. In addition, Modified Example 2 may be combined with the first embodiment and Modified Example 1 described above.

The prediction signal generation unit 241B is configured to generate a prediction signal on the basis of the motion vector output from the motion vector decoding unit 241A. As a method for generating a prediction signal from a motion vector, a known method can be adopted, and thus details thereof will be omitted.

### (Template Matching)

Hereinafter, template matching (TM) according to the first embodiment, Modified Example 1 and Modified Example 2 will be described with reference to FIG. 8.

A TM unit included in the merge unit 241A2 in FIG. 7 is configured to compare the sum of absolute difference (SAD) values of the reconfiguration pixels adjacent to the block and the reference block indicated by the motion vector of the merge candidate illustrated in FIG. 8, and perform TM for re-searching the motion vector starting from the motion vector of the merge candidate in a limited range (in the example of FIG. 8, a range of ±8 pixels).

That is, such a TM unit is configured to re-search for a merge candidate MV and correct the merge candidate MV.

Non Patent Literature 3 discloses a technique related to reordering of merge candidates in a merge list using comparison of SAD values of the TM unit. Specifically, the ten merge candidates in the merge list are classified into five merge candidates (sub groups), and the order of the latter (last) five merge candidates is reordered.

In the reordering method, the ascending numerical order of the merge list is assigned in ascending order of the SAD value by TM. Therefore, the merge index having the short code length can be allocated to the motion information about the reference block having the template similar to the block, so that the transmission code amount of the merge index is reduced, and the encoding performance is improved.

In Modified Example 2, the reordering of merge candidates using the TM may be applied to the first half in the merge list as the MMVD application target candidate. As a result, since the MMVD is preferentially applied to the motion vector of the reference block having a small SAD value, that is, having a similar template, the transmission code amount of mmvd_cand_flag or mmvd_cand_idx is reduced, and as a result, encoding performance is improved.

The reordering of the merge candidates using the TM may be combined with the above-described extension technique of the number and type of merge candidates applicable to the MMVD.

That is, the MMVD unit 241A3 may be configured to reorder the order of the merge candidates in the merge list using TM, and then add the MVD to the merge candidate specified by the decoding unit 210.

Furthermore, the MMVD unit 241A3 may be configured to limit the reordering target of the merge candidates in the merge list based on TM to the spatial merge candidate in the merge list.

Alternatively, the MMVD unit 241A3 may be configured to limit the reordering target of the merge candidates in the merge list based on TM to the spatial merge candidate and the history merge candidate in the merge list.

Alternatively, the MMVD unit 241A3 may be configured to limit the reordering target of the merge candidates in the merge list based on TM to the spatial merge candidate and the non-adjacent spatial merge candidate in the merge list.

Alternatively, the MMVD unit 241A3 may be configured to limit the reordering target of the merge candidates in the merge list based on TM to the spatial merge candidate, the non-adjacent spatial merge candidate, and the history merge candidate in the merge list.

As described above, the MMVD unit 241A3 may be configured to specify a merge candidate by TM.

Furthermore, the MMVD unit 241A3 may be configured to determine the above-described merge candidate as a merge candidate having the minimum SAD value specified by TM.

### (Harmonization of MMVD and TM)

Hereinafter, harmonization of MMVD and TM according to the above-described first embodiment, Modified Example 1, and Modified Example 2 will be described with reference to FIG. 10.

In Non Patent Literature 2, TM is configured such that an MMVD becomes invalid (exclusive control) with respect to a valid block.

Specifically, it can be realized in a manner that a flag (tm_enable_flag) indicating whether or not to apply TM is transmitted from the image encoding device 100 in units of target blocks, the decoding unit 210 decodes the flag, specifies a value of the flag and transmits the value to the MMVD unit 241A3, and the MMVD unit 241A3 determines not to apply the MMVD in a case where tm_enable_flag is valid.

Here, tm_enable_flag is a flag for controlling whether or not to apply TM in units of blocks.

As described above, the MMVD unit 241A3 may be configured to control whether or not to apply the MMVD on the basis of tm_enable_flag. Specifically, the MMVD unit 241A3 may be configured to determine not to apply the MMVD in a case where tm_enable_flag is valid.

On the other hand, in Modified Example 2, when the distance of the MVD in the MMVD is larger than a predetermined threshold (alternatively, the distance of the MVD in the MMVD is equal to or more than a predetermined threshold), TM may be enabled for the motion vector corrected by the MMVD. When the distance of the MVD is equal to or less than the threshold (alternatively, less than such a threshold), the MMVD may be invalidated as described above.

For example, when the distance of the MVD is greater than 8 pixels, TM may be enabled. This is because, since the re-search range of the motion vector by TM disclosed in Non Patent Literature 2 is in the range of ±8 pixels, harmonization (additive effect) with the TM can be expected when the MV is corrected in advance by the MMVD for the block in which the MV exceeding the search range needs to be corrected.

Such a threshold value may be changed depending on the upper limit of the MV re-search range of the TM and a variation in the distance of the MMVD. For example, in a case where the MV re-search range of the TM is ±2 or ±4 and a variation of the distance of MMVD includes these absolute values, the threshold value may be changed to 2 or 4.

That is, the MMVD unit 241A3 may be configured to determine to apply the MMVD even when tm_enable_flag is valid in a case where the distance of the MVD in the MMVD is larger than a predetermined threshold value (alternatively, the distance of the MVD in the MMVD is equal to or more than a predetermined threshold).

### (Syntax Reduction of MMVD Using Template Matching)

Syntax reduction of MMVD using template matching according to the present embodiment will be described below.

In the above example, the merge candidate to which the MMVD is applied is specified by mmvd_cand_flag or mmvd_cand_idx, but these are reduced using TM.

Specifically, the decoding unit 210 may perform template matching (comparison processing of the SAD value between the block and the reconfiguration pixel adjacent to the reference block) and determine an application target of the MMVD as a merge candidate with the smallest SAD.

Here, in a case where the merge candidate is bi-prediction (in a case where the merge candidate has two motion vectors), the SAD value of each reference block may be averaged and compared with the block.

Alternatively, only the SAD value of the reference block having a large difference between the frame number of the block and the number of the reference frame (picture of count (POC)) may be compared.

Here, in the comparison of the SAD values, the pixel values of the left template and the upper template of the target block may be normalized according to the size (aspect ratio) of the target block.

As a result, since the motion vectors of the reference blocks having similar templates can be selected as the application target of the MMVD, the prediction accuracy of MV that is the base of the MMVD is less likely to deteriorate.

Further, since the decoding unit 210 can specify a merge candidate to which the MMVD is applied by using TM without decoding mmvd_cand_flag or mmvd_cand_idx, as a result, it is possible to expect improvement in encoding performance while reducing the code amount of these syntaxes.

Note that, in each of the foregoing embodiments, the present invention has been described by taking application to the image encoding device 100 and the image decoding device 200 by way of an example; however, the present invention is not limited only to such devices and can be similarly applied to encoding/decoding systems provided with each of the functions of an encoding device and a decoding device.

What is claimed is:

1. An image decoding device comprising a circuit, wherein
the circuit:
specifies a merge candidate in a merge list of a normal merge mode for adding a direction, a distance, and an MVD in a merge with motion vector difference, based on syntax transmitted from an image encoding device; and
adds the MVD to an MV indicated by the specified merge candidate to refine the MV, wherein
a merge candidate in a merge list of the normal merge mode is generated and stored by a spatial merge candidate, a temporal merge candidate, a non-adjacent merge candidate, a history merge candidate, a pairwise merge candidate, or a zero merge candidate, and
the circuit specifies the merge candidate from zeroth to fourth merge candidates in the merge list based on syntax transmitted from the image encoding device.

2. An image decoding device according to claim 1, wherein
the circuit specifies the merge candidate from among a spatial merge candidate, a non-adjacent spatial merge candidate, and a history merge candidate in the merge list based on syntax transmitted from the image encoding device.

3. The image decoding device according to claim 1, wherein
the circuit reorders an order of merge candidates in the merge list by using template matching for comparing reconfiguration pixels adjacent to each of a target block and a reference block, and then adds the MVD to the merge candidate specified by the decoding unit.

4. The image decoding device according to claim 1, wherein
the circuit limits a reordering target of merge candidates in the merge list based on the template matching to a spatial merge candidate, a non-adjacent spatial merge candidate, and a history merge candidate in the merge list.

5. The image decoding device according to claim 1, wherein
the circuit:
re-searches an MV of the merge candidate to correct the MV of the merge candidate, wherein
decodes a flag for controlling whether or not to apply the template matching in units of blocks,
controls whether or not to apply the merge with motion vector difference based on the flag, and
determines not to apply the MMVD in a case where the flag is valid.

6. The image decoding device according to claim 5, wherein
the circuit determines to apply the merge with motion vector difference even if the flag is valid, in a case where a distance of an MVD of the merge with motion vector difference is larger than a predetermined threshold value.

7. The image decoding device according to claim 1, wherein
the circuit specifies the merge candidate by using template matching for comparing reconfiguration pixels adjacent to each of a target block and a reference block.

8. The image decoding device according to claim 1, wherein
the circuit determines the merge candidate as a merge candidate having a minimum SAD value specified by using template matching for comparing reconfiguration pixels adjacent to each of a target block and a reference block.

9. An image decoding method comprising:
specifying a merge candidate in a merge list of a normal merge mode for adding a direction, a distance, and an MVD in a merge with motion vector difference, based on syntax transmitted from an image encoding device; and
adding the MVD to an MV indicated by the specified merge candidate to refine the MV, wherein
a merge candidate in a merge list of the normal merge mode is generated and stored by a spatial merge candidate, a temporal merge candidate, a non-adjacent merge candidate, a history merge candidate, a pairwise merge candidate, or a zero merge candidate, and
in the specifying, the merge candidate is specified from zeroth to fourth merge candidates in the merge list based on syntax transmitted from the image encoding device.

10. A program stored on a non-transitory computer-readable medium causing a computer to function as an image decoding device,
the image decoding device comprising a circuit, wherein
the circuit:
specifies a merge candidate in a merge list of a normal merge mode for adding a direction, a distance, and an MVD in a merge with motion vector difference, based on syntax transmitted from an image encoding device; and
adds the MVD to an MV indicated by the specified merge candidate to refine the MV, wherein
a merge candidate in a merge list of the normal merge mode is generated and stored by a spatial merge candidate, a temporal merge candidate, a non-adjacent merge candidate, a history merge candidate, a pairwise merge candidate, or a zero merge candidate, and
the circuit specifies the merge candidate from zeroth to fourth merge candidates in the merge list based on syntax transmitted from the image encoding device.
